(19) United States
(12) Patent Application Publication
(10) Pub. No.: US 2002/0184074 A1
(43) Pub. Date: Dec. 5, 2002

(54) Method for planning product groups

(76) Inventors: Shou-Chung Chen, Kaohsiung (TW); Chi-Hui Yeh, Hsinchu City (TW); Si-Ping Cheng, Hsinchu City (TW); Kenny J. Chien, Hsinchu City (TW)

Correspondence Address: POWELL, GOLDSTEIN, FRAZER & MURPHY LLP, P.O. BOX 97223, WASHINGTON, DC, 20090-7223, US

(21) Appl. No.: 09/870,528

(22) Filed: May 31, 2001

(51) Int. Cl. G06F 17/60

(52) U.S. Cl. 705/10; 705/1

(57) ABSTRACT

A method for planning product groups is provided. The present method is characterized in that selecting processes from a process group according to the rule of the sum of production capacities of the processes in proportion to the total production capacity of the process group not less than a predetermined ratio and the demand production capacity per month of the processes not less than a predetermined value. Then, defining each of selected processes as a product group. Finally, incorporating the unselected processes of the process group into the product groups according to process resemblance.

### BACKGROUND OF THE INVENTION

1. Field of the Invention

The present invention relates to a method for planning product groups for product demand forecast, particularly to a method for planning product groups from process groups.

2. Description of the Prior Art

Within the architecture of a supply chain, it is necessary to attain the purpose of ATP (available to promise) in order to improve the service quality. The meaning of ATP herein represents when a customer gives an order of one product to a supplier, such as a foundry, the supplier can rapidly, e.g. within few minutes, reply the customer quantity of the ordered product can be provided and the supply date. In order to attain the purpose of ATP, the customer needs to provide some forecast data to the supplier in previously, such as the future product capacity, the market demand, etc, so that the supplier could previously plan capacities of various machines to be used. Once the customer gives a product order to the supplier, the supplier will be able to rapidly reply the customer quantity of the ordered product can be provided and the supply date, and thus the demand of the customer is satisfied.

FIG. 1 is a prior flow diagram for planning process groups from a customer's products 1. In general, when performing forecast activity, the supplier divides the products of the customer to process groups, for example, as shown in FIG. 1, process group 111, process group II 12 and process group III 13, in accordance with their process generation, such as 0.18 μm, 0.25 μm and 0.35 μm, etc, their function and their primary manufacturing step. For an IC design company, their products may be classified to three process groups, such as logic, flash memory and DRAM, according to the above rule. The customer usually can provide demand forecast for each of the three process groups, such as the demand quantity for each process group. While the customer could not provide demand forecast for each type of product in each process group to the supplier for orders' distribution forecast. For example, the customer could not provide the demand quantity of each type of product in each process group to the supplier, which depends on the market demand and is fluctuating and indeterminate.

Moreover, there may be many processes in each Process Group, and there are differences between these processes, such as different production capacity, different manufacturing steps and different processing time in a machine, etc. The above demand forecast for each Process Group does not exactly reflect future production capacity of each process. However, it is necessary to utilize various machines to complete a process. Therefore, the supplier would not obtain accurate capacity planning for various machines to be used in accordance with the above demand forecast of process groups.

Accordingly, it is the intention to provide a method for planning product groups to make the product demand forecast more detailed and accurate, and thus the capacities of various machines can be planned more exactly. The production line also can smoothly and stably run.

### SUMMARY OF THE INVENTION

It is the objective of the present invention to provide a method for planning product groups from process groups, which makes the product demand forecast simple, accurate and rapid so as to facilitate to attain the purpose of ATP (available to promise). Therefore, the service quality of a supplier can be improved.

Another objective of the present invention is to provide a method for planning product groups. This makes the product demand forecast more accurate and detailed, so as to obtain more accurate capacity planning for various machines; thus the utilization of the machines is improved.

It is a further objective of the present invention to provide a method for planning product groups. This defines product groups from process groups according to three factors; including the 80/20 principle, capacity sensitivity of a machine, and process resemblance.

It is still a further objective of the present invention to provide a method for determining process resemblance. This evaluates the process resemblance in accordance with difference rate between processes for consuming time in machines.

In order to achieve the above objectives, the present invention provides a method for planning product groups. A process group including a plurality of processes is provided. Sorting the processes according to their respective production capacity. Selecting the processes whose sum of their respective production capacities in proportion to the total production capacity of the process group not less than a predetermined ratio. Defining each of the selected processes as a product group. Incorporating the unselected processes of the process group into the product groups according to process resemblance.

### BRIEF DESCRIPTION OF THE DRAWINGS

The present invention can be best understood through the following description and accompanying drawings, wherein:

FIG. 1 is a prior flow diagram for planning process groups from a customer's product;

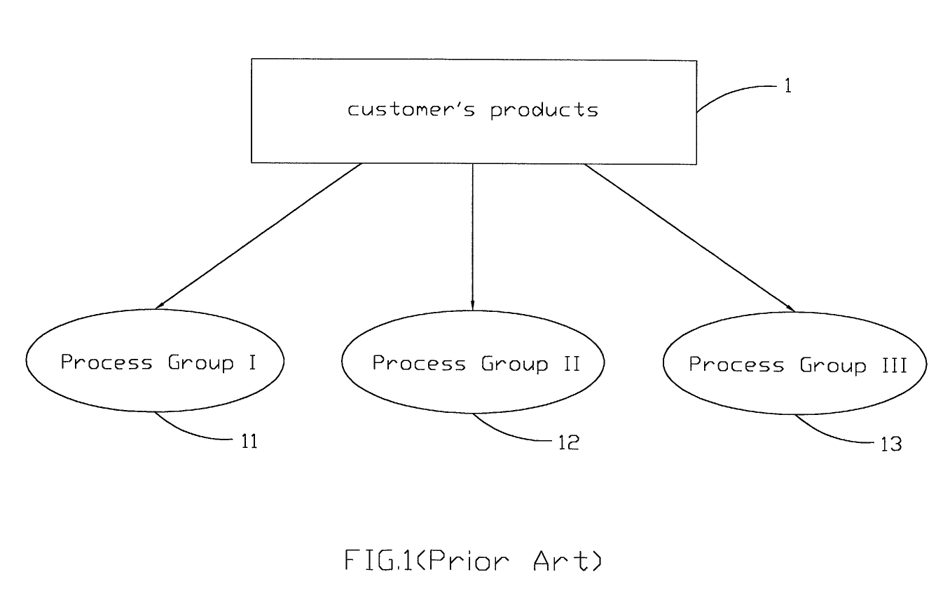

FIG. 2 is a flow diagram for planning product groups from a customer's products according to one embodiment of the present invention; and

FIG. 3 is a process flow for defining product groups from a process group of FIG. 2.

### DESCRIPTION OF THE EMBODIMENTS

The present invention divides the customer's products into process groups according to their process generation, function and primary manufacturing step. Then, planning product groups from each of the process groups. Each process in the process group corresponds to one type of product.

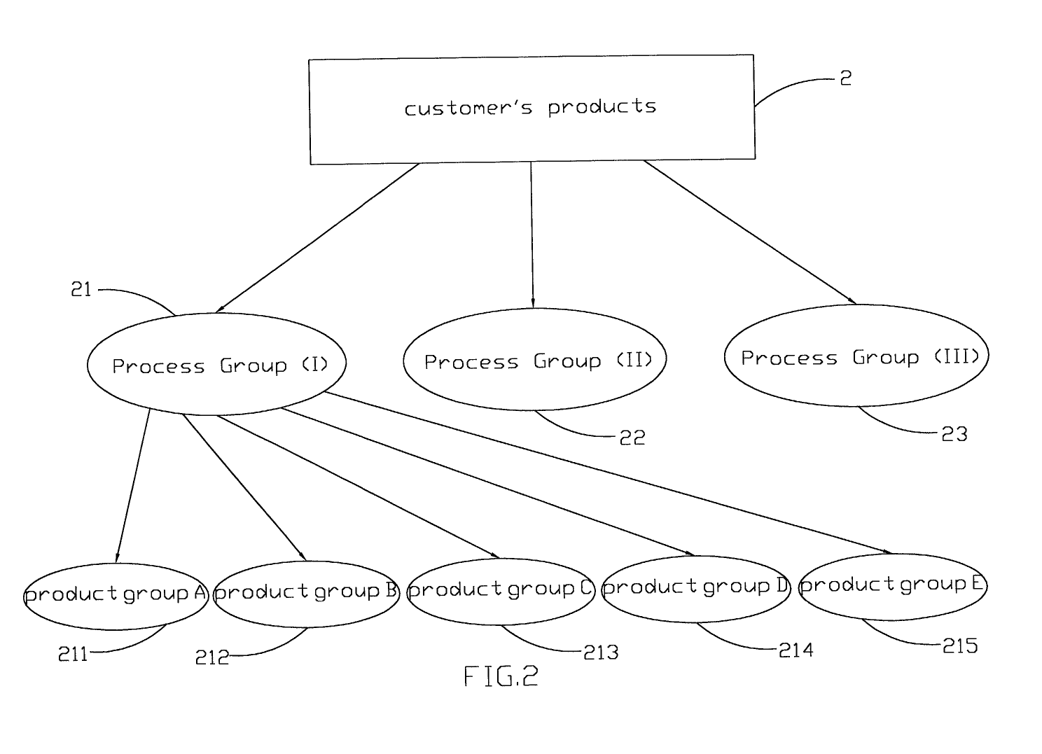

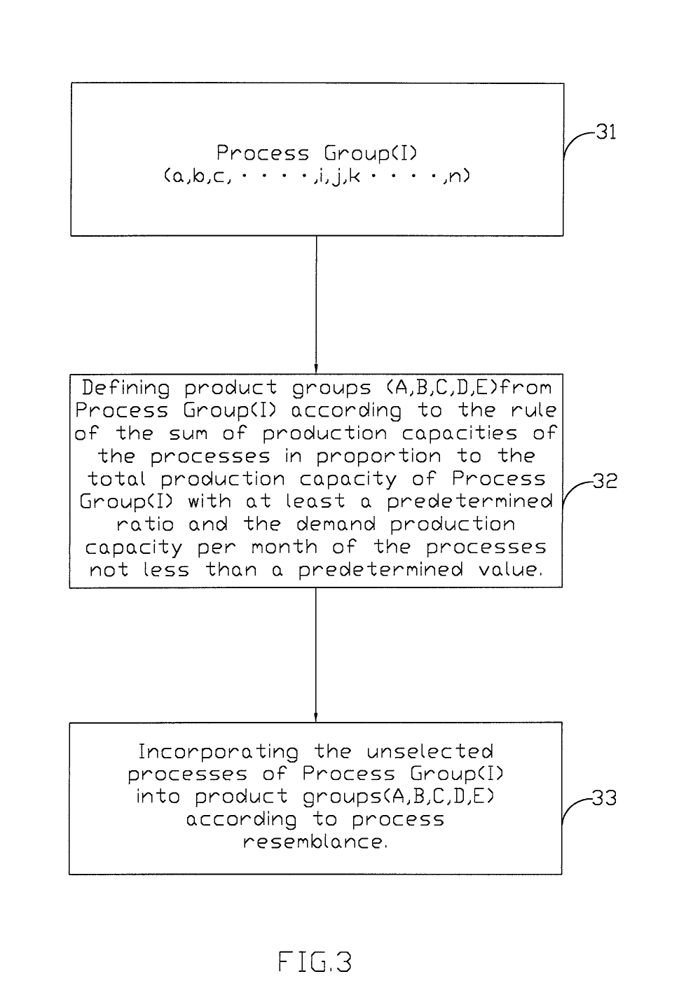

One embodiment of the present invention is described below in detail by referring to drawings of FIG. 2 and FIG. 3.

FIG. 2 is a flow diagram of planning product groups from a customer's products 2 according to one embodiment of the present invention. Initially, the supplier may divide the customer's products 2 into three process groups, process group (I) 21, process group (II) 22 and process group (III) 23, according to their process generation, e.g. 0.18 μm, 0.25 μm and 0.35 μm, their function and their primary manufacturing step. Then, the supplier plans product groups from each of these three process groups. For example, process group (I) 21 is divided into product group A 211, product group B 212, product group C 213, product group D 214 and product group E 215.

The present method for planning product groups from process group (I) 21 is described below with reference to FIG. 3. In step 31, process group (I) 21 including process (a, b, c, . . . , i, j, k, . . . , n) is provided. Sorting processes a, b, c, . . . , i, j, k, . . . , n according to their respective production capacity of the past record. Next, in step 32, from process group (I) 21, selecting the processes whose sum of their respective production capacities in proportion to the total production capacity of process group (I) 21 not less than a predetermined ratio and the processes having respective production capacity per month not less than a predetermined value. The predetermined value can be set as a capacity sensitivity of a machine. The capacity sensitivity of a machine is defined herein as “saturated capacity of a machine for one time”. Then, defining each of the selected processes as a product group. For example, if there are processes a, b, c, d and e selected from the process group (I), and then they will be defined as product group A 211, product group B 212, product group C 213, product group D 214 and product group E 215, respectively. The supplier can select the processes from process group (I) 21 according to the 80/20 principle proposed by the Italian economist, Wilfredo Pareto, in 1897. That is, the processes whose sum of their respective production capacities 80 percent or more of the total production capacity of process group (I) 21 are selected in accordance with the 80/20 principle. And, the processes with a demand production capacity per month not less than capacity sensitivity of a machine are also selected. Thereafter, defining each of the selected processes as a product group.

The following example is provided to explain how to select processes from the process group (I) according to the 80/20 principle and capacity sensitivity of a machine.

Suppose a process group includes process (a), (b), (c), (d) and (e). The total production capacity of the process group is 50000 pieces of wafer. The production capacity of process (a) is 15000 pieces of wafer. The production capacity of a process (b) is 15000 pieces of wafer. The production capacity of a process (c) is 10000 pieces of wafer. The production capacity of process (d) is 4600 pieces of wafer. The production capacity of process (e) is 400 pieces of wafer. According to the 80/20 principle, the processes whose sum of their respective production capacities 80 percent or more of the total production capacity of the process group are selected. Thus, process (a), (b) and (c) are selected. Besides, if capacity sensitivity of a machine is 4000 pieces of wafer, i.e. the saturated capacity of the machine for one time is 40000 pieces of wafer, process (d) also needs to be selected. Therefore, process (a), (b), (c) and (d) are selected from the process group according to the 80/20 principle and capacity sensitivity of a machine. And then, the selected process (a), (b), (c) and (d) are defined as product group (A), (B), (C) and (D), respectively. While, the unselected process (e) is incorporated into one of these product groups in accordance with process resemblance will be described in the following.

Alternately, in step 32, a first predetermined ratio and a second predetermined ratio of the total production capacity of the process group (I) 21 can be set firstly, the first predetermined ratio larger than the second predetermined ratio and the sum of both equal to 1. Then, selecting the processes whose sum of their respective production capacities in proportion to the total production capacity of process group (I) 21 not less than the first predetermined ratio and the processes having respective production capacity per month not less than a predetermined value.

In step 33, incorporating the unselected processes of process group (I) 21 into product group A 211, product group B 212, product group C 213, product group D 214 and product group E 215, in accordance with process resemblance.

The process resemblance is determined according to the following steps:

1. Calculating difference rate between process i and process j for consuming time in machines according to the equation of

$$\frac{{\sum }_{r} ( \frac{\vert P {T}_{r i} - P {T}_{rj} \vert}{P {T}_{r}} ) * {times}_{r}}{{\sum }_{r} {times}_{r}}$$

wherein,

process i represents one of product groups of one process group;

process j represents one of unselected processes of the process group;

PTᵣᵢ represents the unit processing time for process i in machine r;

PTᵣⱼ represents the unit processing time for process j in machine r;

PTᵣ represents the average unit processing time in machine r;

timesᵣ represents total times for process j consuming in machine r;

2. Choosing the minimum difference rate for consuming time in machines to decide which product group that process j belongs to.

For example, suppose process i and process k is a product group. And, process j is to be incorporated into one of these two product groups. At first, calculating the difference rate between process i and process j, and between process k and process j. Finally, choosing the minimum difference rate to decide which product group that process j belongs to.

Process group (II) 22 and process group (III) 23 are planned to their respective product groups by the way as same as the process (I) 21.

After planning product groups, the supplier can readily and more accurately plan the future capacity for various machines and make arrangements for the machines according to the past records of production capacity of each process corresponding to one of the product groups.

Although specific embodiments have been illustrated and described, it will be obvious to those skilled in the art that various modifications may be made without departing from what is intended to be limited solely by the appended claims.

What is claimed is:

1. A method for planning product groups, comprising:
providing a process group including a plurality of processes;
sorting said processes according to their respective production capacity;
selecting said processes whose sum of their respective production capacities in proportion to the total production capacity of said process group not less than a predetermined ratio;
according to said selected processes to define each of said selected processes as a product group; and
incorporating said unselected processes of said process group into said product groups according to process resemblance.

2. The method of claim 1, further comprising defining said process with said production capacity within a certain period not less than a predetermined value as a product group.

3. The method of claim 1, wherein said predetermined ratio is determined according to the 80/20 principleto select said processes whose sum of their respective production capacities not less than eighty percent of the total production capacity of said process group.

4. The method of claim 1, wherein said process resemblance is defined according to following steps:
calculating difference rate between said process i and said process j for consuming time in machines according to the equation of wherein, said process i represents one of said product groups of said
$$\frac{{\sum }_{r} ( \frac{\vert P {T}_{r i} - P {T}_{rj} \vert}{P {T}_{r}} ) * {times}_{r}}{{\sum }_{r} {times}_{r}}$$
process group;
said process j represents one of said unselected processes of said process group;
PTᵣᵢ represents the unit processing time for said process i in said machine r;
PTᵣⱼ represents the unit processing time for said process j in said machine r;
PTᵣ represents the average unit processing time in said machine r;
times ᵣ represents total times for said process j consuming in said machine r; and
determining said process resemblance between said process j and said process i according to said minimum difference rate.

5. A method for planning product groups, comprising:
providing a process group including a plurality of processes;
sorting said processes according to their respective production capacity;
setting a first predetermined ratio and a second predetermined ratio of the total production capacity of said process group, said first predetermined ratio larger than said second predetermined ratio, and the sum of both equal to 1;
selecting said processes whose sum of their respective production capacities in proportion to the total production capacity of said process group not less than said first predetermined ratio;
according to said selected processes to define each of said selected processes as a product group; and
incorporating said unselected processes of said process group into said product groups according to process resemblance.

6. The method of claim 5, further comprising defining said process with said production capacity within a certain period not less than a predetermined value as a product group.

7. The method of claim 5, wherein said process resemblance is defined according to following steps:
calculating difference rate between said process i and said process j for consuming time in machines according to the equation of
$$\frac{{\sum }_{r} ( \frac{\vert P {T}_{r i} - P {T}_{rj} \vert}{P {T}_{r}} ) * {times}_{r}}{{\sum }_{r} {times}_{r}}$$
wherein,
said process i represents one of said product groups of said process group;
said process j represents one of said unselected processes of said process group;
PTᵣᵢ represents the unit processing time for said process i in said machine r;
PTᵣⱼ represents the unit processing time for said process j in said machine r;
PTᵣ represents the average unit processing time in said machine r;
times ᵣ represents total times for said process j consuming in said machine r; and
determining said process resemblance between said process j and said process i according to said minimum difference rate.

8. A method for planning product groups, comprising:
providing a process group including a plurality of processes;
sorting said processes according to their respective production capacity;
according to the 80/20 principle, selecting said processes whose sum of their respective production capacities not less than eighty percent of the total production capacity of said process group, and selecting said process whose said respective production capacity within a certain period not less than a predetermined value;
according to said selected processes to define each of said selected processes as a product group; and
incorporating said unselected processes of said process group into said product groups according to process resemblance.

9. The method of claim 8, wherein said process resemblance is defined according to following steps:
calculating difference rate between said process i and said process j for consuming time in machines according to the equation of
$$\frac{{\sum }_{r} ( \frac{\vert P {T}_{r i} - P {T}_{rj} \vert}{P {T}_{r}} ) * {times}_{r}}{{\sum }_{r} {times}_{r}}$$
wherein,
said process i represents one of said product groups of said process group;
said process j represents one of said unselected processes of said process group;
PTᵣᵢ represents the unit processing time for said process i in said machine r;
PTᵣⱼ represents the unit processing time for said process j in said machine r;
PTᵣ represents the average unit processing time in said machine r;
timesᵣ represents total times for said process j consuming in said machine r; and
determining said process resemblance between said process j and said process i according to said minimum difference rate.
